(19) United States
(12) Patent Application Publication
(10) Pub. No.: US 2022/0172129 A1
(43) Pub. Date: Jun. 2, 2022

(54) CHARGING QUEUE MANAGEMENT SYSTEMS AND METHODS OF ELECTRIC VEHICLE CHARGING STATIONS

(71) Applicant: Noodoe Corporation, Taipei City (TW)

(72) Inventors: Yi-An HOU, Taipei City (TW); Chun-Hung KUNG, Taipei City (TW); Chia-Ying KAO, Taipei City (TW); Hang-An LIU, Taipei City (TW)

(21) Appl. No.: 17/488,432

(22) Filed: Sep. 29, 2021

(30) Foreign Application Priority Data
Nov. 30, 2020 (TW) 109142100

(51) Int. Cl. G06Q 10/02; B60L 53/66

(52) U.S. Cl. CPC G06Q 10/02; B60L 53/66

(57) ABSTRACT

A charging queue management system for electric vehicle charging stations includes at least an electric vehicle charging station and a cloud management server. Cloud management server includes first electric vehicle charging queue recording records real-time charging sequence for first charging requests waiting for charging at electric vehicle charging station and second electric vehicle charging queue recording specific time reservation charging sequence for at least one second charging request corresponding to electric vehicle charging station. Cloud management server detects charging operation for first electric vehicle charging queue, calculates estimated charging completion time for first electric vehicle charging queue, and determines whether third charging request for first electric vehicle is allowed to be placed into real-time charging sequence of first electric vehicle charging queue based on estimated charging completion time for first electric vehicle charging queue and scheduled charging operation time corresponding to second electric vehicle charging queue.

### BACKGROUND OF THE INVENTION

### Field of the Invention

The disclosure relates generally to management systems and methods thereof, and, more particularly to management systems and methods that can perform related charging queue managements for electric vehicle charging stations.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Compared to traditional gasoline vehicles, electric vehicles take longer to charge. Therefore, when the charging station of the charging point is occupied, the user may need to queue to wait for charging. Some charging station operators also provide users of electric vehicles to make appointments for charging at specific charging stations through a dedicated application. Users can use an online queuing function of this application to wait for charging, and then go to the charging station for charging within a specified time after receiving a notification that it is their turn to charge, which can greatly reduce the time spent in queuing at the charging station, and also reduce the possibility of on-site traffic congestion due to queuing traffic. However, if there is no good online queuing management mechanism, other queuing vehicles may jump into the queue or occupy the electric vehicle charging station. Instead, the car owners who reserved for charging will not be able to charge, resulting in a situation where the charging operation cannot be performed after an appointment and causing resentment and complaints from the reserved car owners. As a result, both charging station operators and users cannot achieve the best protection of rights and interests.

### BRIEF SUMMARY OF THE INVENTION

Charging queue management systems and methods for electric vehicle charging stations are provided, which can provide two different queuing modes of real-time charging and reservation charging in a specific time period for each electric vehicle charging station, and can manage multiple charging queues according to the charging operation time in the real-time charging queue and reserved time for reservation charging, to ensure that the reservation charging can be successfully performed in a specific time period through the control of charging queues, so as to provide a variety of charging service options, provide users with a good experience and improve the practicability of charging service, thus reducing the use cost of electric vehicles and increasing the willingness to use electric vehicles.

An embodiment of a charging queue management system for electric vehicle charging stations comprises an electric vehicle charging station and a cloud management server. The electric vehicle charging station outputs electric power for at least one electric vehicle to perform a charging operation. The cloud management server is connected to the electric vehicle charging station via a network, and comprises a first electric vehicle charging queue and a second electric vehicle charging queue, wherein the first electric vehicle charging queue records a real-time charging sequence for a plurality of first charging requests waiting for charging at the electric vehicle charging station and the second electric vehicle charging queue records a specific time reservation charging sequence for at least one second charging request corresponding to the electric vehicle charging station. The cloud management server detects the charging operation corresponding to the first electric vehicle charging queue via the network, calculates an estimated charging completion time corresponding to the first electric vehicle charging queue, and determines whether a third charging request corresponding to a first electric vehicle is allowed to be placed into the real-time charging sequence of the first electric vehicle charging queue based on the estimated charging completion time for the first electric vehicle charging queue and a scheduled charging operation time corresponding to the second electric vehicle charging queue.

In an embodiment of a charging queue management method for electric vehicle charging stations for use in at least one electric vehicle charging station and a cloud management server, wherein the cloud management server is coupled to the at least one electric vehicle charging station through a network, the at least one electric vehicle charging station is provided with a first electric vehicle charging queue and a second electric vehicle charging queue, wherein the first electric vehicle charging queue records a real-time charging sequence for a plurality of first charging requests waiting for charging at the electric vehicle charging station and a second electric vehicle charging queue records a specific time reservation charging sequence for at least one second charging request corresponding to the electric vehicle charging station. The cloud management server detects a charging operation corresponding to the first electric vehicle charging queue via the network and calculates an estimated charging completion time corresponding to the first electric vehicle charging queue. The cloud management server determines whether a third charging request corresponding to a first electric vehicle is allowed to be placed into the real-time charging sequence of the first electric vehicle charging queue based on the estimated charging completion time for the first electric vehicle charging queue and a scheduled charging operation time corresponding to the second electric vehicle charging queue.

In some embodiments, the cloud management server further determines whether the time interval between the scheduled charging operation time corresponding to the second electric vehicle charging queue and the estimated charging completion time of the first electric vehicle charging queue is less than a predetermined threshold value, and refuses the third charging request corresponding to the first electric vehicle to be placed in the first electric vehicle charging queue when the time interval between the scheduled charging operation time corresponding to the second electric vehicle charging queue and the estimated charging completion time of the first electric vehicle charging queue is less than the predetermined threshold value.

In some embodiments, the cloud management server further informs the first electric vehicle to re-allow the third charging request corresponding to the first electric vehicle to be placed into the first electric vehicle charging queue after a charging operation corresponding to the scheduled charging operation time of the second electric vehicle charging queue is completed.

In some embodiments, the predetermined threshold value is in a unit of time segment with fixed time length, and the cloud management server further determines whether the time interval between the scheduled charging operation time corresponding to the second electric vehicle charging queue and the estimated charging completion time of the first electric vehicle charging queue is less than the predetermined threshold value by determining whether the time interval is less than a predetermined number of time segments.

In some embodiments, the cloud management server further inserts at least one second charging request corresponding to the scheduled charging operation time in the second electric vehicle charging queue into the first electric vehicle charging queue such that the at least one second charging request is the next order subsequent to current charging operation in the real-time charging sequence when determining that the time interval between the scheduled charging operation time corresponding to the second electric vehicle charging queue and the estimated charging completion time of the first electric vehicle charging queue is less than the predetermined threshold value.

In some embodiments, the cloud management server further receives a reservation charging request for the second electric vehicle charging queue, and determines whether to place the reservation charging request into the second electric vehicle charging queue according to the estimated charging completion time of the first electric vehicle charging queue and a scheduled charging operation time corresponding to the reservation charging request.

In some embodiments, electricity usage periods corresponding to the electric vehicle charging station include a peak electricity usage period and an off-peak period, and the second electric vehicle charging queue provides a reservation charging schedule within the off-peak period.

In some embodiments, the second electric vehicle charging queue provides a reservation charging schedule corresponding to the second charging request with a specific user identity.

In some embodiments, the cloud management server further obtains a plurality of power states corresponding to the first charging requests and device performance data of the electric vehicle charging station, and calculates the estimated charging completion time corresponding to the first electric vehicle charging queue based on the power states and the device performance data of the electric vehicle charging station.

Charging queue management methods for electric vehicle charging stations may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a charging queue management system of electric vehicle charging stations of the invention;

FIG. 2 is a schematic diagram illustrating an embodiment of an electric vehicle charging station of the invention;

FIG. 3 is a schematic diagram illustrating an embodiment of a cloud management server of the invention;

FIGS. 4A, 4B and 4C are schematic diagrams illustrating embodiments of an electric vehicle charging queue of the invention; and

FIG. 5 is a flowchart of an embodiment of a charging queue management method of electric vehicle charging stations of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof

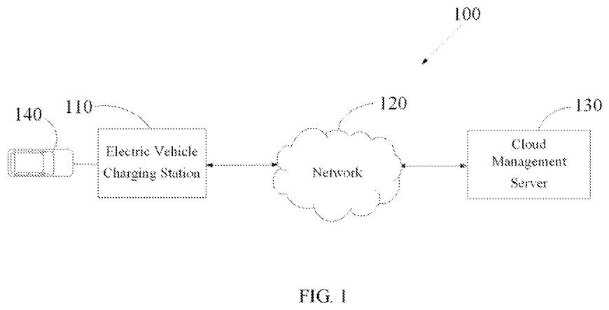

FIG. 1 is a schematic diagram illustrating an embodiment of a charging queue management system of electric vehicle charging stations of the invention. As shown in FIG. 1, the charging queue management system of electric vehicle charging stations 100 of the invention comprises at least one or more electric vehicle charging stations 110 and one cloud management server 130, wherein the cloud management server 130 can be remotely connected with the electric vehicle charging stations 110 through a network 120. In some embodiments, the network 120 may be a wired network, a telecommunication network, and a wireless network, such as a Wi-Fi network or the like. The cloud management server 130 may receive various data from the electric vehicle charging stations 110 via the network 120. For example, when an electric vehicle 140 is connected to the electric vehicle charging station 110 through a charging gun of the electric vehicle charging station 110 to perform a charging operation, the electric vehicle charging station 110 can continuously transmit information of charging state corresponding to the charging operation of the electric vehicle 140 to the cloud management server 130 via the network 120, and the cloud management server 130 can receive the charging information of the corresponding charging operation from the electric vehicle charging station 110 through the network 120. A user of the electric vehicle 140 may connect the electric vehicle 140 with the electric vehicle charging station 110 to send a charging request corresponding to the electric vehicle charging station 110 to perform a charging operation on the electric vehicle 140 using the electric vehicle charging station 110. In some embodiments, the cloud management server 130 may directly or indirectly receive a charging request from a user device (not shown in FIG. 1) of the user of the electric vehicle 140, and after completing payment confirmation and other actions based on the charging request, the cloud management server 130 generates a charging authorization instruction and transmits it to the electric vehicle charging station 110 via the network 120. Accordingly, the cloud management server 130 allows the electric vehicle charging station 110 to output power to the electric vehicle 140, such as an electric scooter or an electric car, which is electrically connected to it or prohibits the electric vehicle charging station 110 from outputting power to the electric vehicle 140. In some embodiments, the user of the electric vehicle 140 can use the user device to download and install an application from the cloud management server 130 via the network 120, and generate the charging request via the user interface of the application. In some embodiments, the user can scan a Quick Response Code (QR code) on the electric vehicle charging station 110 by the scanning function of the application to generate the charging request, thereby activating a charging process. For example, in one embodiment, the electric vehicle charging station 110 may be an electric vehicle charging pedestal, which may have a single or a plurality of charging guns, and power can be output through the charging gun to charge the electric vehicle 140 when the electric vehicle 140 is coupled to the electric vehicle charging station 110 to perform a charging operation through the charging gun of the electric vehicle charging station 110. In an embodiment, the electric vehicle charging station 110 may provide one electric vehicle for charging at a time. In another embodiment, the electric vehicle charging station 110 can provide multiple electric vehicles for charging at the same time. In some embodiments, the electric vehicle charging stations 110 may be home chargers. The user device can be any electronic device with Internet access and positioning capabilities, such as mobile phones, smart phones, personal digital assistants, global positioning systems, notebook computers, and in-vehicle devices. In some embodiments, the user of the electric vehicle can use the user device to download and install an application from the cloud management server 130 via the network 120, and generate the charging request via the user interface of the application. In some embodiments, the user device can receive the charging state and notifications corresponding to the charging operation from the cloud management server 130 through the network 120. The notifications may be messages of notifying that the electric vehicle has stopped charging, notifying the moving, and notifying the charging gun of the electric vehicle charging station has been unplugged from the electric vehicle and so on. The cloud management server 130 may generate an instruction and send it to the electric vehicle charging station 110 via the network 120 to schedule and control operations of the electric vehicle charging station 110 to output power to the electric vehicle 140 that is electrically connected to it at a specified charging efficiency in a specific time period or prohibit the electric vehicle charging station 110 from outputting electric power to the electric vehicle 140.

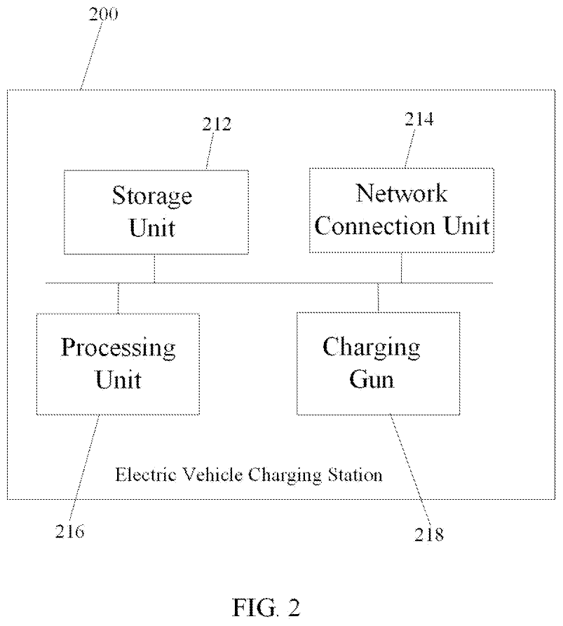

FIG. 2 is a schematic diagram illustrating an embodiment of an electric vehicle charging station of the invention. As shown in FIG. 2, the electric vehicle charging station 200 can be applied to the electric vehicle charging station 110 and has processing and computing capabilities to perform charging management operations for the electric vehicle charging station 200. The electric vehicle charging station 200 has a network connection capability to receive, download or update various parameters and information required for charging management calculations.

The electric vehicle charging station 200 at least comprises a storage unit 212, a network connection unit 214, a processing unit 216, and a charging gun 218. The storage unit 112 may be a memory or a database for storing and recording related data, such as related information of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The processing unit 216 can control related operations of software and hardware in the electric vehicle charging station 110, and perform the charging queue management methods of electric vehicle charging stations, which will be discussed later. For example, the processing unit 216 may be a general-purpose controller, a microcontroller (Micro-Control Unit, MCU), or a digital signal controller (Digital Signal Processor, DSP), etc., to provide data analysis, processing, and calculation operations. In one embodiment, when an electric vehicle is charged by the electric vehicle charging station 200, the processing unit 216 may use the network connection unit 214 to transmit the charging state of the corresponding charging operation to the cloud management server 130 via a network for subsequent charging management. In another embodiment, the processing unit 216 may obtain the corresponding charging efficiency through the cloud management server 130, and charge the electric vehicle according to the charging efficiency. The charging gun 218 may include one or more charging connectors that have the same charging interface specification or have different charging interface specifications. The charging gun 218 is electrically connected to the electric vehicle, and outputs power to the electric vehicle at a specified charging efficiency according to the instruction of the processing unit 216.

In this embodiment, the electric vehicle charging station 200 has a corresponding first electric vehicle charging queue and a second electric vehicle charging queue, wherein the first electric vehicle charging queue records a real-time charging sequence for a plurality of first charging requests waiting for charging at the electric vehicle charging station 200 and a second electric vehicle charging queue records a specific time reservation charging sequence for at least one second charging request corresponding to the electric vehicle charging station 200. In one embodiment, the first electric vehicle charging queue and the second electric vehicle charging queue are recorded only on the cloud management server 130. In another embodiment, the first electric vehicle charging queue and the second electric vehicle charging queue are recorded in the storage unit of the cloud management server 130 and the storage unit 212 of the electric vehicle charging station 200 at the same time, and the cloud management server 130 performs the queue management of the first electric vehicle charging queue and the second electric vehicle charging queue. The above queue management at least includes operations of allowing or prohibiting a charging request to be placed into (inserted to) the electric vehicle charging queue, deleting or removing a charging request in the electric vehicle charging queue, adjusting the sorting of existing charging requests in the electric vehicle charging queue, and moving a charging request from one electric vehicle charging queue to another electric vehicle charging queue (for example, moving a charging request from the second electric vehicle charging queue to the first electric vehicle charging queue), etc., but the present invention is not limited thereto.

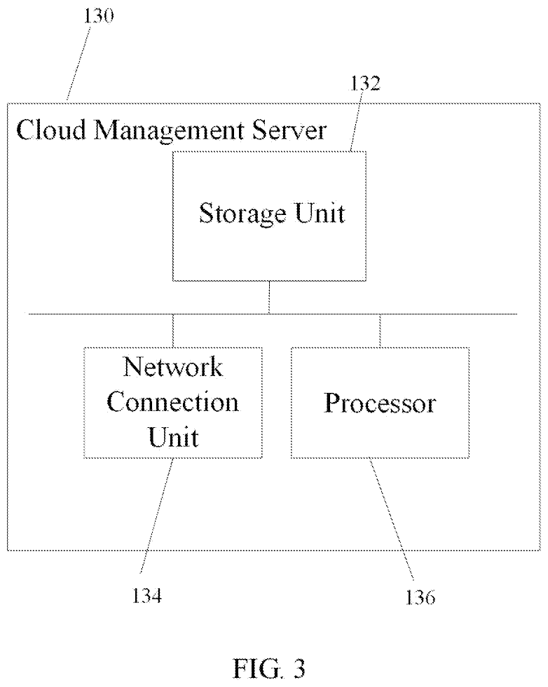

FIG. 3 is a schematic diagram illustrating an embodiment of a cloud management server of the invention. As shown in FIG. 3, the cloud management server 130 of the invention can be any processor-based electronic device, which comprises at least a storage unit 132, a network connection unit 134, and a processor 136. It is noted that the cloud management server 130 may receive various data from the electric vehicle charging stations. The cloud management server 130 may directly or indirectly receive a charging request from a user device of the user of the electric vehicle, and after completing payment confirmation and other actions based on the charging request, the cloud management server 130 generates a charging authorization instruction and transmits it to respective electric vehicle charging station via the network. Accordingly, the cloud management server 130 allows the electric vehicle charging station to output power to the electric vehicle, such as an electric scooter or an electric car, which is electrically connected to it or prohibits the electric vehicle charging station from outputting power to the electric vehicle. In some embodiments, the electric vehicle charging equipment corresponding to the cloud management server 130 can be an electric vehicle charger, which may have a single charging gun or multiple charging guns, and can output power to the electric vehicle through the charging gun (s) for charging.

The storage unit 132 (for example, a memory) may store and record related data, such as various data corresponding to the electric vehicle charging station 110, the electric vehicle charging queues of the electric vehicle charging station 110, and so on. For example, the storage unit 132 may record a first electric vehicle charging queue and a second electric vehicle charging queue corresponding to the electric vehicle charging station 110, wherein the first electric vehicle charging queue records a real-time charging sequence for a plurality of first charging requests waiting for charging at the electric vehicle charging station 110 and a second electric vehicle charging queue records a specific time reservation charging sequence for at least one second charging request corresponding to the electric vehicle charging station 110, but the invention is not limited thereto. The network connection unit 134 can couple to the electric vehicle charging stations 110 through the network 120, such as a wired network, a telecommunication network, and a wireless network, such as a Wi-Fi network. Through the network connection unit 134, the cloud management server 130 can couple and communicate with the electric vehicle charging stations 110 through the network to perform charging management operations for the electric vehicle charging stations 110 to control the electric vehicle charging station 110 whether to output power to an electric vehicle that is electrically connected to it or prohibit the electric vehicle charging station 110 from outputting electric power to the electric vehicle. The processor 136 can control the related operations of software and hardware in the server 130, and perform the charging queue management methods of electric vehicle charging stations of the invention, which will be discussed later. For example, the processor 136 may be a general-purpose controller, a microcontroller (Micro-Control Unit, MCU), or a digital signal controller (Digital Signal Processor, DSP), etc., to provide data analysis, processing, and calculation functions. However, it is understood that the present invention is not limited thereto.

The cloud management server 130 may generate an instruction and send it to the electric vehicle charging station 110 via the network 120 to schedule and control operations of the electric vehicle charging station 110 to output power to an electric vehicle that is electrically connected to it or prohibit the electric vehicle charging station 110 from outputting electric power to the electric vehicle at a specified charging efficiency in a specific time period. The cloud management server 130 can perform queue management of the first electric vehicle charging queue and the second electric vehicle charging queue. The above queue management at least includes operations of allowing or prohibiting a charging request to be placed into (inserted to) the electric vehicle charging queue, deleting or removing a charging request in the electric vehicle charging queue, adjusting the sorting of existing charging requests in the electric vehicle charging queue, and moving a charging request from one electric vehicle charging queue to another electric vehicle charging queue (for example, moving a charging request from the second electric vehicle charging queue to the first electric vehicle charging queue), etc., but the present invention is not limited thereto.

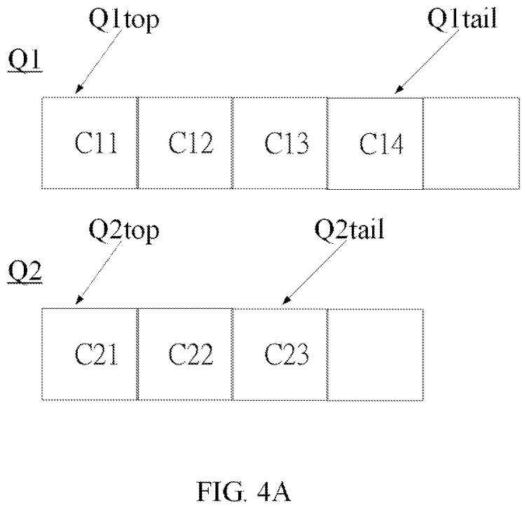

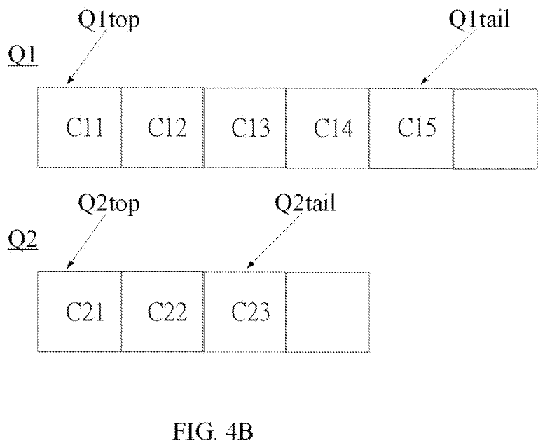

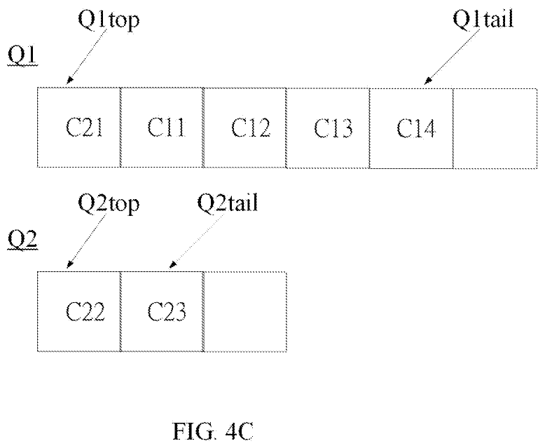

FIG. 4A, FIG. 4B and FIG. 4C are schematic diagrams illustrating embodiments of an electric vehicle charging queue of the invention. As shown in FIG. 4A, the electric vehicle charging station 110 includes two corresponding electric vehicle charging queues Q1 and Q2, wherein the electric vehicle charging queue Q1 has a queue top Q1top and a queue tail Q1tail, and the electric vehicle charging queue Q2 has a queue top Q2top and a queue tail Q2tail. The electric vehicle charging queue Q1 records a plurality of charging requests C11, C12, C13 and C14 waiting for charging at the electric vehicle charging station 110, wherein each charging request corresponds to a specific electric vehicle and/or a user corresponding to the specific electric vehicle, and the position order of each charging request in the queue represents the real-time charging order of the corresponding charging operation. In the electric vehicle charging queue Q1 of FIG. 4A, the charging request C11 at the top Q1top of the queue has the first priority, the charging request C12 has the second priority, the charging request C13 has the third priority, and the charging request C14 at the tail Q1tail of the queue has the last priority. Therefore, the order of real-time charging is C11 C12, C13 and C14 in sequence. That is, the cloud management server 130 will preferentially perform a first charging operation of the charging request C11 at the first priority in the queue Q1, and then sequentially perform a second charging operation of the charging request C12 at the second priority in the queue Q1, a third charging operation of the charging request C13 at the third priority in the queue Q1 and a fourth charging operation of the charging request C14 at the fourth priority in the queue Q1 after the first charging operation is completed. Similarly, the electric vehicle charging queue Q2 records at least one second charging request C21 corresponding to the electric vehicle charging station 110, wherein each charging request corresponds to a specific electric vehicle and/ or a user of the corresponding specific electric vehicle, and the position order of each charging request in the queue represents the reservation charging order for a specific time period of the charging operation. In the electric vehicle charging queue Q2 in FIG. 4A, the charging request C21 at the top Q2top of the queue has a first reservation time, the charging request C22 has a second reservation time, and the charging request C23 at the tail Q1tail of the queue has a third reservation time. Since the electric vehicle charging queue Q2 records the reservation charging sequence for a specific time period, the charging operations for the charging requests C21, C22 and C23 will be performed sequentially when the first reservation time, the second reservation time and the third reservation time arrive in sequence. That is, the cloud management server 130 will execute a fifth charging operation of the charging request C21 at the first reservation time, a sixth charging operation of the charging request C22 at the second reservation time, and a seventh charging operation of the charging request C23 at the third reservation time. When a new user wants to queue up for charging and send a new charging request C15 to the cloud management server 130, the cloud management server 130 can place the new charging request C15 into the electric vehicle charging queue Q1, and the tail of the queue Q1tail points to the charging request C15, as shown in FIG. 4B. The cloud management server 130 can also move the charging request C21 from the electric vehicle charging queue Q2 to the electric vehicle charging queue Q1, such as placing the charging request C21 into the top Q1 top of the electric vehicle charging queue Q1 and deleting the charging request C21 from the electric vehicle charging queue Q2, as shown in FIG. 4C. In other words, the cloud management server 130 will first perform the fifth charging operation of the charging request C21 at the first priority in the queue Q1 (i.e., Q1top at the top of the queue Q1).

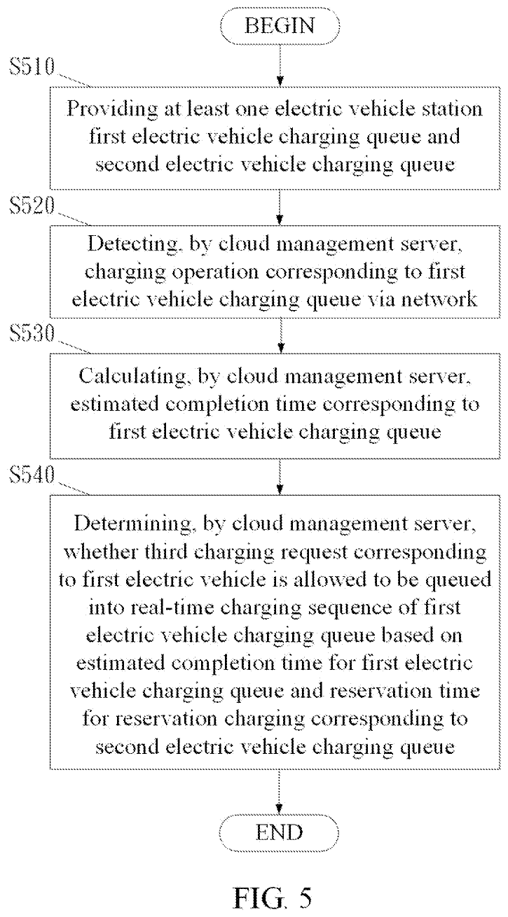

FIG. 5 is a flowchart of an embodiment of a charging queue management method of electric vehicle charging stations of the invention. The charging queue management method of electric vehicle charging stations of the invention can be used in a cloud management server, such as the cloud management server 130 as shown in FIG. 1, and performed by the processor 136 of the cloud management server 130. The server 120 can be coupled to each electric vehicle charging station via a network, such as a wired network, a telecommunications network, and a wireless network such as a Wi-Fi network.

First, in step S510, a first electric vehicle charging queue and a second electric vehicle charging queue are provided to the at least one electric vehicle charging station, wherein the first electric vehicle charging queue records a real-time charging sequence for a plurality of first charging requests waiting for charging at the electric vehicle charging station and a second electric vehicle charging queue records a specific time reservation charging sequence for at least one second charging request corresponding to the electric vehicle charging station. In one embodiment, the first electric vehicle charging queue and the second electric vehicle charging queue are recorded only on the cloud management server. In another embodiment, the first electric vehicle charging queue and the second electric vehicle charging queue are recorded in the storage units of the cloud management server and the electric vehicle charging station at the same time, and the cloud management server performs the queue management of the first electric vehicle charging queue and the second electric vehicle charging queue. The above queue management at least includes operations of allowing or prohibiting a charging request to be placed into (inserted to) the electric vehicle charging queue, deleting or removing a charging request in the electric vehicle charging queue, adjusting the sorting of existing charging requests in the electric vehicle charging queue, and moving a charging request from one electric vehicle charging queue to another electric vehicle charging queue (for example, moving a charging request from the second electric vehicle charging queue to the first electric vehicle charging queue), etc., but the present invention is not limited thereto.

Next, in step S520, a charging operation corresponding to the first electric vehicle charging queue is detected by the cloud management server via the network and in step S530, an estimated charging completion time corresponding to the first electric vehicle charging queue is calculated by the cloud management server. It should be noted that the server may periodically receive power usage information transmitted by the charging device via the network during the period when the charging device is outputting power to charge the electric vehicle (i.e., during the charging process of the electric vehicle). To be more specific, the electric vehicle charging station may periodically detect and report the power usage information of the electric vehicle to the cloud management server during the charging process of the electric vehicle. In some embodiments, the cloud management server may periodically request the electric vehicle charging station to detect and report the charging status of the electric vehicle during the charging process of the electric vehicle to obtain the power usage information of the electric vehicle. In one embodiment, the power usage information of the electric vehicle at least includes information regarding charging status, such as a charging time, a charging progress and so on. Thereafter, the cloud management server can calculate the estimated charging completion time corresponding to the first electric vehicle charging queue based on the power usage information of the electric vehicle charging station and the estimated charging times required for all the charging requests queued in the current first electric vehicle charging queue. In some embodiments, the cloud management server may further obtain a plurality of power states corresponding to the first charging requests and device performance data of the electric vehicle charging station, and calculates the estimated charging completion time corresponding to the first electric vehicle charging queue based on the power states and the device performance data of the electric vehicle charging station. In some embodiments, the first electric vehicle charging queue is set to have a maximum operation time, that is, the operation time of each first charging request does not exceed the maximum operation time, so the cloud management server may calculate the estimated charging completion time corresponding to the first electric vehicle charging queue based on the number of first charging requests and the maximum operation time. It is noted that, aforementioned method of calculating the estimated charging completion time corresponding to the first electric vehicle charging queue is merely examples of the application, and the present invention is not limited thereto. Any method that can be used to calculate the estimated charging completion time corresponding to the first electric vehicle charging queue can also be applied to the present invention.

Then, in step S540, the cloud management server determines whether a third charging request corresponding to a first electric vehicle is allowed to be placed into the real-time charging sequence of the first electric vehicle charging queue based on the estimated charging completion time for the first electric vehicle charging queue and a scheduled charging operation time corresponding to the second electric vehicle charging queue. In some embodiments, the cloud management server may determine whether a time interval between the scheduled charging operation time corresponding to the second electric vehicle charging queue and the estimated charging completion time of the first electric vehicle charging queue is less than a predetermined threshold value, and it determines to place the third charging request corresponding to the first electric vehicle into the real-time charging sequence of the first electric vehicle charging queue when the time interval between the scheduled charging operation time corresponding to the second electric vehicle charging queue and the estimated charging completion time of the first electric vehicle charging queue is greater than or equal to the predetermined threshold value while it refuses to place the third charging request corresponding to the first electric vehicle into the first electric vehicle charging queue when the time interval between the scheduled charging operation time corresponding to the second electric vehicle charging queue and the estimated charging completion time of the first electric vehicle charging queue is less than the predetermined threshold value.

For example, assuming that the scheduled charging operation time of the second electric vehicle charging queue is 3 pm and the predetermined threshold value is set to be half an hour, when the estimated charging completion time of the first electric vehicle charging queue is at 2 pm, the cloud management server determines that the time interval between the scheduled charging operation time corresponding to the second electric vehicle charging queue and the estimated charging completion time of the first electric vehicle charging queue is greater than half an hour, which means that the queue for the real-time charging can be allowed, so the cloud management server will queue the third charging request corresponding to the first electric vehicle into the first electric vehicle charging queue. In this example, when the estimated charging completion time of the first electric vehicle charging queue is at 2:40 pm, the cloud management server determines that the time interval between the scheduled charging operation time corresponding to the second electric vehicle charging queue and the estimated charging completion time of the first electric vehicle charging queue is less than half an hour, which means that the queue for the real-time charging can't be allowed, and thus it rejects the third charging request and refuses to place the third charging request into the first second electric vehicle charging queue. In some embodiments, after the cloud management server rejects the third charging request, it further informs the first electric vehicle to re-allow the third charging request corresponding to the first electric vehicle to be placed into the first electric vehicle charging queue after a charging operation corresponding to the scheduled charging operation time of the second electric vehicle charging queue is completed. In one embodiment, placing the third charging request into the first electric vehicle charging queue is to insert the charging operation corresponding to the third charging request into the last position at the tail of the first electric vehicle charging queue. In another embodiment, placing the third charging request into the first electric vehicle charging queue is to insert the charging operation corresponding to the third charging request into any position in the first electric vehicle charging queue.

In some embodiments, the predetermined threshold value is in a unit of time segment with fixed time length, and the cloud management server may further determine whether the time interval between the scheduled charging operation time corresponding to the second electric vehicle charging queue and the estimated charging completion time of the first electric vehicle charging queue is less than the predetermined threshold value by determining whether the time interval is less than a predetermined number of time segments.

In some embodiments, the cloud management server further inserts at least one second charging request corresponding to the scheduled charging operation time in the second electric vehicle charging queue into the first electric vehicle charging queue such that the at least one second charging request is the next order subsequent to current charging operation in the real-time charging sequence when determining that the time interval between the scheduled charging operation time corresponding to the second electric vehicle charging queue and the estimated charging completion time of the first electric vehicle charging queue is less than the predetermined threshold value. In other words, when the current charging operation under execution is the first order at the top of the first electric vehicle charging queue, the charging operation corresponding to at least one second charging request will be placed into the second order of the first electric vehicle charging queue, so that the charging operation corresponding to the at least one second charging request will be executed in priority, which can effectively reduce the delay time of reservation charging after the current charging operation is completed.

In some embodiments, when the cloud management server receives a reservation charging request with a scheduled charging operation time for the second electric vehicle charging queue, it determines whether to place the reservation charging request into the second electric vehicle charging queue according to the estimated charging completion time of the first electric vehicle charging queue and the scheduled charging operation time corresponding to the reservation charging request. The cloud management server may further determine whether the time interval between the scheduled charging operation time corresponding to the reservation charging request and the estimated charging completion time of the first electric vehicle charging queue is less than a predetermined threshold value. When the time interval between the scheduled charging operation time corresponding to the reservation charging request and the estimated charging completion time of the first electric vehicle charging queue is greater than or equal to the predetermined threshold value, the cloud management server further places the reservation charging request into the second electric vehicle charging queue. When the time interval between the scheduled charging operation time corresponding to the reservation charging request and the estimated charging completion time of the first electric vehicle charging queue is less than the predetermined threshold value, it refuses the reservation charging request to be placed in the second electric vehicle charging queue. That is, the cloud management server will reject this reservation charging request. For example, assuming that the estimated charging completion time of the first electric vehicle charging queue is 2 pm and the predetermined threshold value is set to be half an hour, when the user is ready to make a reservation charging at 3 pm, the cloud management server determines that the time interval between the scheduled charging operation time corresponding to the reservation charging request and the estimated charging completion time of the first electric vehicle charging queue is greater than half an hour, which means that this reservation can be allowed, so the cloud management server will queue the reservation charging request into the second electric vehicle charging queue. In this example, when another user is ready to make a reservation charging at 2:20 pm, the cloud management server determines that the time interval between the scheduled charging operation time corresponding to the reservation charging request and the estimated charging completion time of the first electric vehicle charging queue is less than half an hour, which indicates that the reservation can't be allowed. Therefore, the cloud management server will reject the reservation charging request, and refuses to place the reservation charging request into the second electric vehicle charging queue. In one embodiment, after the cloud management server rejects the reservation charging request, it will send an instruction message to a user device corresponding to the reservation charging request through a network, wherein a user uses this user device to send the reservation charging request, and the instruction message informs the user of corresponding to the user device that the reservation has failed and provides related information about the nearest available reservation time. If the user still wants to make a reservation charging, he or she can resend a reservation charging request with a scheduled charging operation time corresponding to the reservation charging request to complete the reservation and the reservation charging request can be placed into the second electric vehicle charging queue.

In some embodiments, the cloud management server further determines whether to accept the reservation charging of the second electric vehicle charging queue depends on an electricity usage period corresponding to the electric vehicle charging station. Note that electricity usage periods corresponding to the electric vehicle charging station may include a peak electricity usage period and an off-peak period, and the second electric vehicle charging queue provides a reservation charging schedule within the off-peak period only. In other words, the second electric vehicle charging queue may record all reservation charging schedules during the off-peak periods, and only reservation charging requests whose scheduled charging period is within the off-peak period can be placed into the second electric vehicle charging queue. For example, in one embodiment, the off-peak period is defined as the times form eleven o'clock in the evening to eight o'clock in the morning of the next day.

When a first reservation charging request corresponding to a charging time of twelve o'clock in the evening is received, the cloud management server determines that the reserved time period belongs to the off-peak period, and thus allows the first reservation charging request to be queued/placed into the second electric vehicle charging queue. When receiving a second reservation charging request corresponding to a charging time of ten o'clock in the evening, the cloud management server determines that the reserved time period is not the off-peak period, and thus refuses to place the second scheduled charging request into the second electric vehicle charging queue.

In some embodiments, the cloud management server further determines whether to accept the reservation charging of the second electric vehicle charging queue depends on a user identity of a user of the electric vehicle corresponding to a second charging request, wherein the second electric vehicle charging queue provides a reservation charging schedule corresponding to the second charging request with a specific user identity. To be more specific, the specific user identity is for users with a specific member level, and the second electric vehicle charging queue provides reservation charging for a specific time period. It should be note that only users who reach a predetermined member level can make reservation charging for a specific time period, issue the aforementioned second charging request and apply for being placed into the second electric vehicle charging queue. For example, assuming that the user identity of users can be divided into general members and VIP members, the second electric vehicle charging queue may only provide the reservation charging schedule of the second charging request for users with the user identity of VIP members. In other words, users with the user identity of general members can only make an instant charging reservation through the first electric vehicle charging queue, while users with the user identity of VIP members can make an instant charging queue through the first electric vehicle charging queue or choose to make a reservation charging for a specified time period through the second electric vehicle charging queue.

Therefore, the charging queue management system and method for electric vehicle charging stations of the present invention can provide two different queuing modes of real-time charging and reservation charging in a specific time period for each electric vehicle charging station, and can manage multiple charging queues according to the charging operation time in the real-time charging queue and reserved time for reservation charging, to ensure that the reservation charging can be successfully performed in a specific time period through the control of charging queues, so as to provide a variety of charging service options, provide users with a good experience and improve the practicability of charging service, thus reducing the use cost of electric vehicles and increasing the willingness to use electric vehicles.

Charging queue management methods for electric vehicle charging stations, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging queue management system for electric vehicle charging stations, comprising:
an electric vehicle charging station outputting electric power for at least one electric vehicle to perform a charging operation; and
a cloud management server connected to the electric vehicle charging station via a network, including a first electric vehicle charging queue and a second electric vehicle charging queue, wherein the first electric vehicle charging queue records a real-time charging sequence for a plurality of first charging requests waiting for charging at the electric vehicle charging station and the second electric vehicle charging queue records a specific time reservation charging sequence for at least one second charging request corresponding to the electric vehicle charging station, detecting the charging operation corresponding to the first electric vehicle charging queue via the network, calculating an estimated charging completion time corresponding to the first electric vehicle charging queue, and determining whether a third charging request corresponding to a first electric vehicle is allowed to be placed into the real-time charging sequence of the first electric vehicle charging queue based on the estimated charging completion time for the first electric vehicle charging queue and a scheduled charging operation time corresponding to the second electric vehicle charging queue.

2. The system of claim 1, wherein the cloud management server further determines whether the time interval between the scheduled charging operation time corresponding to the second electric vehicle charging queue and the estimated charging completion time of the first electric vehicle charging queue is less than a predetermined threshold value, and refuses the third charging request corresponding to the first electric vehicle to be placed in the first electric vehicle charging queue when the time interval between the scheduled charging operation time corresponding to the second electric vehicle charging queue and the estimated charging completion time of the first electric vehicle charging queue is less than the predetermined threshold value.

3. The system of claim 2, wherein the cloud management server further informs the first electric vehicle to re-allow the third charging request corresponding to the first electric vehicle to be placed into the first electric vehicle charging queue after a charging operation corresponding to the scheduled charging operation time of the second electric vehicle charging queue is completed.

4. The system of claim 2, wherein the predetermined threshold value is in a unit of time segment with fixed time length, and the cloud management server further determines whether the time interval between the scheduled charging operation time corresponding to the second electric vehicle charging queue and the estimated charging completion time of the first electric vehicle charging queue is less than the predetermined threshold value by determining whether the time interval is less than a predetermined number of time segments.

5. The system of claim 2, wherein the cloud management server further inserts at least one second charging request corresponding to the scheduled charging operation time in the second electric vehicle charging queue into the first electric vehicle charging queue such that the at least one second charging request is the next order subsequent to current charging operation in the real-time charging sequence when determining that the time interval between the scheduled charging operation time corresponding to the second electric vehicle charging queue and the estimated charging completion time of the first electric vehicle charging queue is less than the predetermined threshold value.

6. The system of claim 1, wherein the cloud management server further receives a reservation charging request for the second electric vehicle charging queue, and determines whether to place the reservation charging request into the second electric vehicle charging queue according to the estimated charging completion time of the first electric vehicle charging queue and a scheduled charging operation time corresponding to the reservation charging request.

7. The system of claim 1, wherein electricity usage periods corresponding to the electric vehicle charging station include a peak electricity usage period and an off-peak period, and the second electric vehicle charging queue provides a reservation charging schedule within the off-peak period.

8. The system of claim 1, wherein the second electric vehicle charging queue provides a reservation charging schedule corresponding to the second charging request with a specific user identity.

9. The system of claim 1, wherein the cloud management server further obtains a plurality of power states corresponding to the first charging requests and device performance data of the electric vehicle charging station, and calculates the estimated charging completion time corresponding to the first electric vehicle charging queue based on the power states and the device performance data of the electric vehicle charging station.

10. A charging queue management method for electric vehicle charging stations for use in at least one electric vehicle charging station and a cloud management server, wherein the cloud management server is coupled to the at least one electric vehicle charging station through a network, and the method further comprises the steps of:
providing the at least one electric vehicle charging station a first electric vehicle charging queue and a second electric vehicle charging queue, wherein the first electric vehicle charging queue records a real-time charging sequence for a plurality of first charging requests waiting for charging at the electric vehicle charging station and a second electric vehicle charging queue records a specific time reservation charging sequence for at least one second charging request corresponding to the electric vehicle charging station;
detecting, by the cloud management server, a charging operation corresponding to the first electric vehicle charging queue via the network; and
calculating, by the cloud management server, an estimated charging completion time corresponding to the first electric vehicle charging queue, and determining whether a third charging request corresponding to a first electric vehicle is allowed to be placed into the real-time charging sequence of the first electric vehicle charging queue based on the estimated charging completion time for the first electric vehicle charging queue and a scheduled charging operation time corresponding to the second electric vehicle charging queue,
wherein the determination of whether the third charging request corresponding to the first electric vehicle is allowed to be placed into the real-time charging sequence of the first electric vehicle charging queue based on the estimated charging completion time for the first electric vehicle charging queue and the scheduled charging operation time corresponding to the second electric vehicle charging queue further comprises the steps of determining whether a time interval between the scheduled charging operation time corresponding to the second electric vehicle charging queue and the estimated charging completion time of the first electric vehicle charging queue is less than a predetermined threshold value, and refusing the third charging request corresponding to the first electric vehicle to be placed in the first electric vehicle charging queue when the time interval between the scheduled charging operation time corresponding to the second electric vehicle charging queue and the estimated charging completion time of the first electric vehicle charging queue is less than the predetermined threshold value.
